(19) United States
(12) Patent Application Publication
(10) Pub. No.: US 2011/0003155 A1
(43) Pub. Date: Jan. 6, 2011

(54) POLYURETHANE NANOMETER POWDER OF WHICH SURFACE IS MODIFIED WITH PHOSPHORIC ACID AND ITS PREPARATION METHOD

(75) Inventors: Jian Shen, Nanjing (CN); Xiaohua Huang, Nanjing (CN); Hongke Liu, Nanjing (CN); Dan Zhu, Nanjing (CN); Jianchun Bao, Nanjing (CN); Chun Mao, Nanjing (CN)

Correspondence Address: SCHMEISER, OLSEN & WATTS, 22 CENTURY HILL DRIVE, SUITE 302, LATHAM, NY, 12110, US

(73) Assignee: NANJING NORMAL UNIVERSITY

(21) Appl. No.: 12/819,297

(22) Filed: Jun. 21, 2010

(30) Foreign Application Priority Data
Jul. 1, 2009 (CN) 200910032541.1

(51) Int. Cl. B32B 5/16; B05D 7/02; B06B 1/20

(52) U.S. Cl. 428/407; 427/222; 427/601

(57) ABSTRACT

The present invention relates to a surface chemically modified organic high polymer nanometer powder and its preparation method. The phosphoric acid modified nanometer powdery material of the present invention is polyether polyurethane or polyester polyurethane nanometer powder. The surface of the powder has self-assembled phosphate groups. It is prepared by the following method: phosphate groups are introduced into polyether polyurethane or polyester polyurethane nanometer powder in a phosphoric acid buffer solution by means of physical adsorption. This method can improve the stability and dispersibility of the powder and change its physical, chemical and biological properties and hopefully will realize intensive and extensive application in biomedical field. The surface modified nanometer powder of the present invention is in a controllable size of 50 nm˜500 nm and its surface Zeta potential in physiological environment is negative. The present invention is characterized by simple process route, small energy consumption and no pollution. It provides a new thought for the surface modification of organic high polymer nanometer powder and also widens the road of the development and utilization of high polymer nanometer medical material.

### FIELD OF THE TECHNOLOGY

The present invention relates to the synthesis of a polyurethane nanometer powdery material of which surface is modified with phosphoric acid.

### BACKGROUND

Polyurethane (PU) refers to the high polymer of which main chain contains urethane (—NHCOO—) characteristic groups. From the reaction between polyisocyanate and polyether or polyester polyol, —N═C═O+HO—→—NHCOO—, polyether or polyester polyurethane is obtained. Since PU was first synthesized by Bayer in 1937, it has quickly achieved wide application in the fields of coating, foam and elastomer. The animal experiments done by Boretor, Pietrce and et al in 1967 indicate polyurethane elastomer has good biostability and anticoagulation property. Since then, people have researched and developed a great many polyether polyurethane biomedical materials and formed a series of medical materials with practical value, such as: artificial cardiac valves and artificial blood vessels.

PU powder is an upstream and basic raw material of industrial manufacturing and has extremely wide application in automobile manufacturing industry, electronic component industry, daily chemical industry, and the fields of catalytic cracking of petroleum, molecular sieves, detergents, cleaning agents, product modification, metal smelting, chemical synthesis, aeronautics and astronautics, high temperature superconductors and machinery manufacturing, and particularly high-tech field. After nanotechnology made breakthrough in 1990s, the research on its application in biomedical field has been constantly extended. The powder with a particle diameter of tens to thousands of nanometers is called nanometer powder. The current highlights of the research on organic high polymer nanometer powder are drug control release materials and gene therapeutic vector materials. The particle size of the nanometer polyurethane material prepared through emulsion polymerization is tens to hundreds of nanometers. The characteristic effects of surface and volume increase the density of the functional groups of nanometer particles, enhance selective adsorption capacity, shorten the time of the realization of adsorption equilibrium, and improve particle colloid stability. Nanometer polyurethane material has a very promising application prospect in the aspects of medical immunoassay, drug control release carriers, intervention treatment and so on.

Self-emulsification is one of the common industrial methods for preparation of stable polyurethane waterborne emulsion. The key is to introduce hydrophilic groups (mostly are the groups that may form ionic bonds) to the molecular skeletons of polyurethane through chain extension of hydrophilic monomers. The self-emulsifier used in the above method is diol chain-extender containing cationic ammonia salt or anionic carboxylate. Demulsification is a process in which emulsion is broken and separated into two phases, and the dispersion phase is aggregated. One of the demulsification methods universally used in industry is addition of demulsifier. The demulsifier goes between the two phases and destroys the interface stability of emulsion, thus the dispersion phase is aggregated and separated out of the emulsion. In this process, the selection of demulsifier and the control of the physical and chemical states of the emulsion are very important, because during the aggregation and separation of dispersion phase, nanometer powder may often loses its small-size form due to improper reaction conditions.

As the obtained nanometer powder has a large specific surface area and high surface energy, it is extremely prone to agglomeration, which not only creates great inconvenience for preparation, storage and application but also makes nanomaterial lose its characteristic features, and has become a bottleneck of material application and development and the advancement of nanotechnology. Following the continuous development of nanotechnology and the continuous deepening of nanomaterial research, surface modification is gaining broader attention and application in solving the problem of poor dispersibility and stability of nanometer particles and even in improving physical, chemical and biological properties.

### SUMMARY

As mentioned in the above background of the invention, organic high polymer micro-nano material has poor stability and dispersibility, and its biocompatibility is not desirable when it is used in organisms. These have limited its application. To address this problem, the present invention provides a method to modify the surface of organic high polymer nanometer ultrafine power with phosphoric acid.

The present invention discloses a polyurethane-based nanometer powdery material of which surface is modified with phosphoric acid. It is polyether polyurethane or polyester polyurethane nanometer powder. The surface of the powder has self-assembled phosphate groups.

The particle diameter of the said polyurethane-based nanometer powdery material of which surface is modified with phosphoric acid is 50 nm˜500 nm. Its surface potential in a physiological solution is negative.

The present invention also discloses a preparation method of the said polyurethane-based nanometer powdery material of which surface is modified with phosphoric acid, wherein phosphate groups are introduced to the surface of the polyether polyurethane or polyester polyurethane nanometer powder in a phosphoric acid buffer system by means of physical adsorption.

In the method of the present invention, the said polyether or polyester polyurethane nanometer powder is prepared by emulsification process and demulsification method from the raw material polyether (polyester) diols and diisocyanate used during the conventional preparation of polyurethane waterborne emulsion.

The concrete operation of the method of the present invention is as follows:

Polyether or polyester polyurethane waterborne nanometer emulsion is synthesized by using N-methyl diethanol amine or dicarboxymethyl propanoic acid as a hydrophilic chain-extender, 0.2 mol/L pH=7.0 phosphoric acid buffer solution and toluene are added into the synthesized polyurethane emulsion under ultrasonic vibration (the volume ratio of the three is 1:1:1), the reaction goes on 24 h under ultrasonic action, the upper-layer clear toluene liquid is removed after quiescence, the lower-layer emulsion is dialyzed, soaked and cleaned with deionized water and then freeze dried, and in this way the polyurethane nanometer powder of which surface is modified with phosphoric acid is obtained.

The particle diameter of the obtained micro-nano polyurethane powder of which surface is modified with phosphoric acid is 50 nm˜500 nm, and its surface potential in a physiological solution is −3.2˜−0.6 V. Thrombin time and prothrombin time indicate the powder has good anticoagulation property.

The present invention draws on the preparation of the polyurethane nanometer emulsion with polyurethane resin as matrix and water as dispersion medium. Firstly, we obtained polyurethane nanometer powdery material at normal temperature by the method of nanometer emulsion synthesis and chemical demulsification. After that, we made physical phosphorylated modification to the surface of the powder by the method of electrostatic adsorption and obtained surface-modified polyurethane nanometer powder with a particle diameter of 50 nm˜500 nm. The powder has narrow distribution of particle diameter and stable structure and properties and can realize good biocompatibility. The present invention provides a noveller thought and broader application prospect for the development of the drugs using micro-nano ultrafine powder as carrier, and for the research of the biological materials using micro-nano ultrafine powder as coat.

### BRIEF DESCRIPTION OF THE DRAWINGS

FIG. 1 is the stereoscan photographs of the polyurethane nanometer powders of which surface is modified with phosphoric acid and of which average particle diameter is 200 nm(A) and 400 nm(B), respectively.

FIG. 2 is a particle diameter distribution diagram of the polyurethane nanometer powder of which surface is modified with phosphoric acid and of which average particle diameter is 200 nm, measured by LLS (laser light scattering).

FIG. 3 is a Zeta potential diagram of the polyurethane nanometer powder of which surface is modified with phosphoric acid in physiological environment.

FIG. 4 is the H-NMR (A) and P-NMR (B) of the polyurethane nanometer powder of which surface is modified with phosphoric acid.

### DETAILED DESCRIPTION

Unless otherwise specified, the terms used in the present invention have the meanings usually understood by the ordinary persons skilled in the art.

More detailed description of the present invention is given below in combination of concrete preparation embodiments and application embodiments and in consultation with data. It should be understood that these embodiments are only examples used to explain the present invention, other than limitations of any form to the range of the present invention.

In the embodiments below, the processes and methods not described in details are conventional methods commonly known in the art. The sources and trade names of the reagents used as well as their components that need to be listed are stated when they appear in the first time. Unless otherwise specified, the same reagents used subsequently all bear the same information given in the first time.

### Embodiment 1

Polyurethane nanometer powder of which surface is modified with phosphoric acid and of which particle diameter is about 200 nm, and its preparation

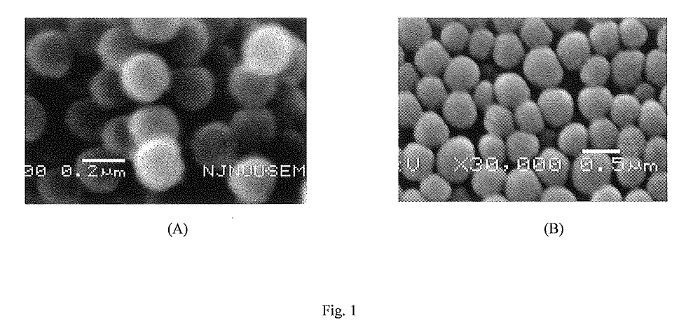

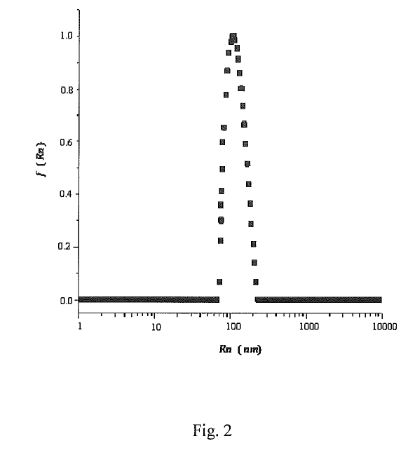

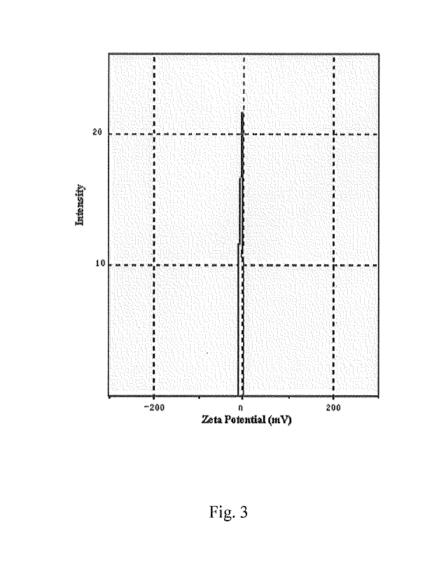

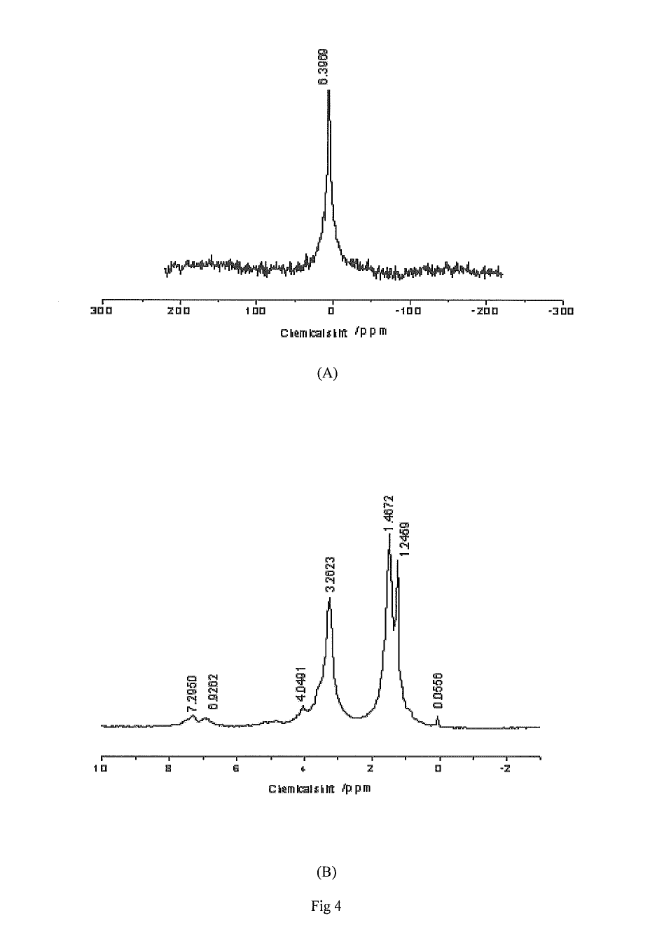

Put 4.2 g of MDI dissolved in 200 ml of ethyl acetate and 7.5 g of molten PTMG (PTMG, 2000) into a four-neck flask equipped with a condenser tube, a mechanical agitator, a nitrogen port and a thermometer, add dropwise DMPA NMP solution (6% solution, containing 0.9 g of DMPA), react 3 h at 80° C. under nitrogen protection and mechanical agitation, add excessive isopropanol or normal butanol for termination, add triethylamine solution to adjust the PH value of the solution to neutral, add dropwise 50 ml of deionized water that contains 10% dodecyl sodium sulfate, and agitate violently and emulsify the solution to obtain nanometer waterborne emulsion. Add 0.2 mol/L pH=7.0 phosphoric acid buffer solution and toluene into the above synthesized polyurethane emulsion under ultrasonic vibration (the volume ratio of the three is 1:1:1), react 24 h under ultrasonic action, let stand, remove the upper-layer clear toluene liquid, dialyze, soak and clean the lower-layer emulsion with deionized water and then freeze dry it to obtain the polyurethane nanometer powder of which surface is modified with phosphoric acid. The average particle diameter of the powder is 234 nm (See FIG. 1A), the distribution of its particle diameter is narrow (See FIG. 2), its potential in a physiological solution is negative (See FIG. 3), and phosphate groups have been established in the nanometer material (See FIG. 4). Moreover, the powder can lengthen blood coagulation time, thus possessing good anticoagulation property (See Table 1).

TABLE 1
Thrombin time and prothrombin time of polyurethane nanometer
powder of which surface is modified with phosphoric acid, and
heparin as a reference substance

| | Concentration | Thrombin | Prothrombin |
|---|---|---|---|
| | (μg/mL) | time (s) | time (s) |
| Polyurethane nanometer | 0 | 36.3 ± 5.3 | 12.7 ± 2.1 |
| powder of which surface is | 10 | 38.7 ± 4.6 | 13.3 ± 3.4 |
| modified with phosphoric acid | 15 | 41.3 ± 5.6 | 13.7 ± 2.8 |
| Heparin | 0 | 36.4 ± 3.6 | 12.8 ± 0.9 |
| | 10 | >200 | 67.2 ± 2.8 |
| | 15 | >200 | 76.2 ± 3.3 |

### Embodiment 2

Polyurethane nanometer powders of which surface is modified with phosphoric acid and of which particle diameter is about 50 nm, 400 nm and 500 nm, respectively, and their preparation

The amount of the surfactant added during emulsification in embodiment 1 is adjusted to concentration 20%, 4% and 2%, respectively, and the types and amount of other reagents and the steps are all same as those in embodiment 1. In this way, polyurethane nanometer powders of which surface is modified with phosphoric acid and of which average particle diameter is 50 nm, 400 nm (See FIG. 1B) and 500 nm, respectively are obtained.

1. A polyurethane-based nanometer powdery material of which surface is modified with phosphoric acid, wherein the surface of polyether polyurethane or polyester polyurethane nanometer powder has phosphate groups.

2. The nanometer powdery material of which surface is modified with phosphoric acid as set forth in claim 1, wherein its particle diameter is 50 nm˜500 nm and surface potential in a physiological solution is negative.

3. A preparation method of the polyurethane-based nanometer powdery material of which surface is modified with phosphoric acid as set forth in claim 1, wherein phosphate groups are introduced to the surface of polyether polyurethane or polyester polyurethane nanometer powder in a phosphoric acid buffer solution by means of physical adsorption.

4. The preparation method of a polyurethane-based nanometer powdery material of which surface is modified with phosphoric acid as set forth in claim 3, wherein the said polyether or polyester polyurethane nanometer powder is prepared by emulsification process and demulsification method.

5. The preparation method of a polyurethane-based nanometer powdery material of which surface is modified with phosphoric acid as set forth in claim 4, wherein polyether or polyester polyurethane waterborne nanometer emulsion is synthesized by using N-methyl diethanol amine or dicarboxymethyl propanoic acid as a hydrophilic chain-extender, an equal volume of 0.2 mol/L pH=7.0 phosphoric acid buffer solution and toluene are added into the synthesized polyurethane emulsion under ultrasonic vibration, the reaction goes on 24h under ultrasonic action, the upper-layer clear toluene liquid is removed after quiescence, the lower-layer emulsion is dialyzed, soaked and cleaned with deionized water and then freeze dried, and in this way the polyurethane nanometer powder of which surface is modified with phosphoric acid is obtained.
